(19) United States
(12) Patent Application Publication
(10) Pub. No.: US 2025/0370253 A1
(43) Pub. Date: Dec. 4, 2025

(54) IMAGING LENS ASSEMBLY AND ELECTRONIC DEVICE

(71) Applicant: LARGAN PRECISION CO., LTD., Taichung City (TW)

(72) Inventors: Ssu-Hsin LIU, Taichung City (TW); Chun-Jui PAN, Taichung City (TW); Chen-Wei FAN, Taichung City (TW)

(21) Appl. No.: 19/216,798

(22) Filed: May 23, 2025

Related U.S. Application Data
(60) Provisional application No. 63/654,362, filed on May 31, 2024.

(51) Int. Cl. G02B 27/00; G02B 13/00; G03B 11/00; G03B 17/17; G03B 30/00; H04N 23/55

(52) U.S. Cl. CPC G02B 27/0018; G02B 13/0065; G03B 11/00; G03B 17/17; G03B 30/00; H04N 23/55

(57) ABSTRACT

An imaging lens assembly has an optical axis, and includes a lens element, a reflective element and a light blocking element, wherein the optical axis passes through the lens element. The reflective element is disposed on an object side or an image side of the lens element, and includes a first reflecting surface. The light blocking element is disposed corresponding to the lens element or the reflective element, and includes a first light blocking surface and a plurality of protruding structures. The first light blocking surface is disposed between the lens element and the reflective element, and the protruding structures are disposed on the first light blocking surface and arranged in a two-dimensional array. On a section coinciding with the optical axis, a first angle is formed between the first light blocking surface and the optical axis.

### RELATED APPLICATIONS

This application claims priority to U.S. Provisional Application Ser. No. 63/654,362, filed May 31, 2024, which is herein incorporated by reference.

### BACKGROUND

### Technical Field

The present disclosure relates to an imaging lens assembly. More particularly, the present disclosure relates to an imaging lens assembly applicable to portable electronic devices.

### Description of Related Art

In the recent years, portable electronic devices have developed rapidly. For example, intelligent electronic devices and tablets have been filled in the lives of modern people, and imaging lens assemblies mounted on portable electronic devices have also prospered. However, as technology advances, the quality requirements of the imaging lens assemblies are becoming higher and higher. Therefore, an imaging lens assembly, which can reduce a stray light, needs to be developed.

### SUMMARY

According to one aspect of the present disclosure, an imaging lens assembly has an optical axis, and includes a lens element, a reflective element and a light blocking element. The optical axis passes through the lens element. The reflective element is disposed on an object side or an image side of the lens element, and includes a first reflecting surface. The first reflecting surface is configured to fold the optical axis. The light blocking element is opaque, the light blocking element is disposed corresponding to the lens element or the reflective element, and the light blocking element includes a first light blocking surface and a plurality of protruding structures. The first light blocking surface is disposed between the lens element and the reflective element. The protruding structures are disposed on the first light blocking surface and arranged in a two-dimensional array, the protruding structures and the first light blocking surface are formed integrally, a section of a bottom of each of the protruding structures is circular, and each of the protruding structures protrudes from the bottom in a direction away from the first light blocking surface to form an arc surface on a top of each of the protruding structures. On a section coinciding with the optical axis, a first angle is formed between the first light blocking surface and the optical axis, when the first angle is Oa, the following condition is satisfied: 0.86<sin θa≤1.

According to one aspect of the present disclosure, an imaging lens assembly has an optical axis, and includes a lens element, a reflective element and a light blocking element. The optical axis passes through the lens element. The reflective element is disposed on an object side or an image side of the lens element, and includes a first reflecting surface. The first reflecting surface is configured to fold the optical axis. The light blocking element is opaque, the light blocking element is disposed corresponding to the lens element or the reflective element, and the light blocking element includes a first light blocking surface and a plurality of protruding structures. The first light blocking surface is disposed between the lens element and the reflective element. The protruding structures are disposed on the first light blocking surface and arranged in a two-dimensional array, the protruding structures and the first light blocking surface are formed integrally, and each of the protruding structures protrudes from a bottom in a direction away from the first light blocking surface. On a section coinciding with the optical axis, a first angle is formed between the first light blocking surface and the optical axis, when the first angle is ea, the following condition is satisfied: 0.86<sin θa≤1.

According to one aspect of the present disclosure, an imaging lens assembly has an optical axis, and includes an optical element, an image sensor and a light blocking element. The optical element is translucent, and the optical axis passes through the optical element. The image sensor is configured to sense a light, and disposed corresponding to the optical element. The light blocking element is opaque, the light blocking element is disposed corresponding to the optical element or the image sensor, and the light blocking element includes a first light blocking surface and a plurality of protruding structures. The first light blocking surface is disposed between the optical element and the image sensor. The protruding structures are disposed on the first light blocking surface and arranged in a two-dimensional array, the protruding structures and the first light blocking surface are formed integrally, a section of a bottom of each of the protruding structures is circular, and each of the protruding structures protrudes from the bottom in a direction away from the first light blocking surface to form an arc surface on a top of each of the protruding structures. On a section coinciding with the optical axis, a first angle is formed between the first light blocking surface and the optical axis, when the first angle is ea, the following condition is satisfied: 0.86<sin θa≤1.

According to one aspect of the present disclosure, an imaging lens assembly has an optical axis, and includes a lens element and a light blocking element. The optical axis passes through the lens element. The light blocking element is opaque, the light blocking element is disposed corresponding to the lens element, and the light blocking element includes a first light blocking surface and a plurality of protruding structures. The first light blocking surface faces towards an image side, and is disposed adjacent to the lens element. The protruding structures are disposed on the first light blocking surface and arranged in a two-dimensional array, the protruding structures and the first light blocking surface are formed integrally, a section of a bottom of each of the protruding structures is circular, and each of the protruding structures protrudes from the bottom in a direction away from the first light blocking surface to form an arc surface on a top of each of the protruding structures. On a section coinciding with the optical axis, a first angle is formed between the first light blocking surface and the optical axis, when the first angle is 0a, the following condition is satisfied: 0.86<sin θa≤1.

According to one aspect of the present disclosure, an electronic device includes the imaging lens assembly of any one of the aforementioned aspects.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging lens assembly according to the 1st Example of the 1st Embodiment of the present disclosure.

FIG. 1B is a partial enlarged view of the imaging lens assembly according to the 1st Example of the 1st Embodiment in FIG. 1A.

FIG. 1C is a three-dimensional view of a lens element and a light blocking element according to the 1st Example of the 1st Embodiment in FIG. 1A.

FIG. 1D is a partial enlarged view of the light blocking element according to the 1st Example of the 1st Embodiment in FIG. 1A.

FIG. 1E is a schematic view of the light blocking element according to the 1st Example of the 1st Embodiment in FIG. 1D.

FIG. 1F is a cross-sectional view of the light blocking element along a cross line 1F-1F according to the 1st Example of the 1st Embodiment in FIG. 1E.

FIG. 1G is a partial enlarged view of a light blocking element according to the 2nd Example of the 1st Embodiment of the present disclosure.

FIG. 1H is a cross-sectional view of the light blocking element according to the 2nd Example of the 1st Embodiment in FIG. 1G.

FIG. 1I is a partial enlarged view of the imaging lens assembly according to the 3rd Example of the 1st Embodiment of the present disclosure.

FIG. 1J is a schematic view of an image sensor and a light blocking element according to the 3rd Example of the 1st Embodiment in FIG. 1I.

FIG. 2A is a schematic view of an imaging lens assembly according to the 1st Example of the 2nd Embodiment of the present disclosure.

FIG. 2B is a partial enlarged view of the imaging lens assembly according to the 1st Example of the 2nd Embodiment in FIG. 2A.

FIG. 2C is a partial three-dimensional view of the imaging lens assembly according to the 1st Example of the 2nd Embodiment in FIG. 2A.

FIG. 2D is a schematic view of the imaging lens assembly according to the 2nd Example of the 2nd Embodiment of the present disclosure.

FIG. 2E is a three-dimensional view of the lens element and a light blocking element according to the 2nd Example of the 2nd Embodiment in FIG. 2D.

FIG. 3A is a schematic view of an imaging lens assembly according to the 1st Example of the 3rd Embodiment of the present disclosure.

FIG. 3B is a partial enlarged view of a light blocking element according to the 1st Example of the 3rd Embodiment in FIG. 3A.

FIG. 4A is a schematic view of an electronic device according to the 4th Embodiment of the present disclosure.

FIG. 4B is another schematic view of the electronic device according to the 4th Embodiment in FIG. 4A.

FIG. 4C is a schematic view of an image captured via the electronic device according to the 4th Embodiment in FIG. 4A.

FIG. 4D is a schematic view of another image captured via the electronic device according to the 4th Embodiment in FIG. 4A.

FIG. 4E is a schematic view of another image captured via the electronic device according to the 4th Embodiment in FIG. 4A.

FIG. 5 is a schematic view of an electronic device according to the 5th Embodiment of the present disclosure.

FIG. 6A is a schematic view of a vehicle instrument according to the 6th Embodiment of the present disclosure.

FIG. 6B is another schematic view of the vehicle instrument according to the 6th Embodiment in FIG. 6A.

FIG. 6C is another schematic view of the vehicle instrument according to the 6th Embodiment in FIG. 6A.

### DETAILED DESCRIPTION

The present disclosure provides an imaging lens assembly, the imaging lens assembly has an optical axis and includes a lens element and a light blocking element, and the optical axis passes through the lens element. The light blocking element is opaque, and the light blocking element includes a first light blocking surface and a plurality of protruding structures. The protruding structures are disposed on the first light blocking surface and arranged in a two-dimensional array, the protruding structures and the first light blocking surface are formed integrally, wherein each of the protruding structures protrudes from a bottom in a direction away from the first light blocking surface. On a section coinciding with the optical axis, a first angle is formed between the first light blocking surface and the optical axis, when the first angle is ea, the following condition is satisfied: 0.86<sin θa≤1. Specifically, the two-dimensional array can be a linear array, a curved array, a circular array, etc., and a light trap structure can be formed by the protruding structures arranged in the two-dimensional array. Therefore, it is favorable for reducing the stray light. When the first angle meets the condition, it is favorable for the stray light entering the protruding structures so that the stray light is reduced between the protruding structures, and it is beneficial to improve the molding quality of the protruding structures. Moreover, when the first angle is ea, the following condition can be satisfied: 0.96<sin θa≤1.

The light blocking element can be disposed corresponding to the lens element, the first light blocking surface of the light blocking element can face towards an image side, and the first light blocking surface can be disposed adjacent to the lens element.

Furthermore, the imaging lens assembly can further include a reflective element. The reflective element can be disposed on an object side or an image side of the lens element, and can include a first reflecting surface. The first reflecting surface is configured to fold the optical axis. Further, the light blocking element can be disposed corresponding to the lens element or the reflective element, and the first light blocking surface can be disposed between the lens element and the reflective element.

Moreover, a section of the bottom of each of the protruding structures can be circular, and each of the protruding structures protrudes from the bottom in a direction away from the first light blocking surface to form an arc surface on a top of each of the protruding structures. Therefore, when the section of the bottom of each of the protruding structures is circular, it is favorable for reducing the stray light between the protruding structures.

The first angle formed between the first light blocking surface and the optical axis can change with a distance from the optical axis. Therefore, it is favorable for reducing impacts caused by the stray light from various incident directions. Specifically, the first angle formed between the first light blocking surface and the optical axis is not constant.

Moreover, the first light blocking surface faces towards the reflective element, the first light blocking surface can include a reverse inclined portion, and the reverse inclined portion is gradually away from the reflective element in a direction away from the optical axis. Therefore, it is favorable for guiding the stray light to the outside of the reflective element.

The first angle is formed between the reverse inclined portion and the optical axis, when the first angle is ea, the following condition can be satisfied: −0.5≤cos θa<0.

The protruding structures are arranged in an array in a direction away from the optical axis. On the section coinciding with the optical axis, the top of one of the protruding structures closest to the optical axis is taken as a reference point, when a distance between the reference point and the optical axis and in a direction perpendicular to the optical axis is X, and a distance between the reference point and the reflective element or between the reference point and the lens element faced by the first light blocking surface and in a direction parallel to the optical axis is Y, the following condition can be satisfied: 0.03<Y/X<0.76. When the arrangement of the protruding structures meets the condition, it is favorable for the stray light entering the light trap structure formed by the protruding structures arranged in the two-dimensional array, so that the effect of reducing the stray light can be improved.

Furthermore, the protruding structures can be further arranged in an array in a direction surrounding the optical axis. Therefore, it is favorable for reducing the stray light incident from various directions by the protruding structures arranged in the two-dimensional array and improving the effect of the light trap structure in destroying the stray light.

When a height of each of the protruding structures is H, the following condition can be satisfied: 6 μm<H<102 μm. Therefore, the light trap structure is with a sufficient ability to trap the stray light. Specifically, when the first light blocking surface is an inclined surface, the height of each of the protruding structures is calculated according to a central axis of each of the protruding structures.

When the height of each of the protruding structures is H, and a height difference between adjacent two of the protruding structures on the section coinciding with the optical axis is AH, the following condition can be satisfied: 0.05<ΔH/H<0.55. In detail, an appropriate ratio of the height difference to the height is favorable for trapping the stray light.

When the height difference between adjacent two of the protruding structures on the section coinciding with the optical axis is AH, the following condition can be satisfied: 1.5 μm<ΔH<29 μm. Specifically, an appropriate height difference is favorable for the stray light entering the protruding structures. Therefore, the stray light can be reduced by the protruding structures.

A distance between adjacent two of the protruding structures can be greater than the height of each of the protruding structures. Therefore, it is favorable for the stray light reflecting between the protruding structures so as to reduce the stray light. Specifically, the distance between adjacent two of the protruding structures is calculated according to central axes of the adjacent two of the protruding structures.

The light blocking element can further include a second light blocking surface, the second light blocking surface can include a plurality of strip structures, the strip structures are arranged in an array in a direction surrounding the optical axis, and a cross-section of each of the strip structures is triangular. Therefore, it is favorable for reducing stray lights with different types.

On the section coinciding with the optical axis, a second angle is formed between the second light blocking surface and the optical axis, when the second angle is Ob, the following condition can be satisfied: 0.5<cos θb<1. In detail, when the second angle formed between the second light blocking surface and the optical axis is too small to dispose the protruding structures, the strip structures is favorable for avoiding the stray light generating on the second light blocking surface. Specifically, the combination of the reverse inclined portion and the second light blocking surface can form a groove-like structure. Moreover, the light blocking element with the reverse inclined portion can be designed with the second light blocking surface so that an abutting mechanism of the light blocking element can be easily designed to abut other elements.

The reflective element can further include a second reflecting surface configured to fold the optical axis again. Therefore, it is favorable for compressing the volume of the imaging lens assembly.

The reflective element can further include an incident surface and an exit surface, the optical axis enters the reflective element through the incident surface, and the optical axis exits the reflective element through the exit surface, wherein the incident surface and the exit surface are the same surface. Therefore, it is favorable for compressing the volume of the imaging lens assembly.

A number of the lens element can be at least two, and a distance between two lens elements is variable. Therefore, it is favorable for the imaging lens assembly being with the ability to change the shooting focal length.

The present disclosure provides an imaging lens assembly, the imaging lens assembly has an optical axis and includes an optical element, an image sensor and a light blocking element. The optical element is translucent, and the optical axis passes through the optical element. The image sensor is configured to sense a light, and disposed corresponding to the optical element. The light blocking element is opaque, the light blocking element is disposed corresponding to the optical element or the image sensor, and the light blocking element includes a first light blocking surface and a plurality of protruding structures. The first light blocking surface is disposed between the optical element and the image sensor. The protruding structures are disposed on the first light blocking surface and arranged in a two-dimensional array, the protruding structures and the first light blocking surface are formed integrally, and a section of a bottom of each of the protruding structures is circular, wherein each of the protruding structures protrudes from the bottom in a direction away from the first light blocking surface to form an arc surface on a top of each of the protruding structures. On a section coinciding with the optical axis, a first angle is formed between the first light blocking surface and the optical axis, when the first angle is θa, the following condition is satisfied: 0.86<sin θa≤1. Specifically, the image sensor can be moved relative to the optical element, and thereby the functions of optical focusing and optical anti-shacking can be achieved. Moreover, the two-dimensional array can be a linear array, a curved array, a circular array, etc., and a light trap structure can be formed by the protruding structures arranged in the two-dimensional array. Therefore, it is favorable for reducing the stray light. When the first angle meets the condition, it is favorable for the stray light entering the protruding structures so that the stray light is reduced between the protruding structures, and it is beneficial to improve the molding quality of the protruding structures. Moreover, when the first angle is ea, the following condition can be satisfied: 0.96<sin θa≤1.

The first angle formed between the first light blocking surface and the optical axis can change with a distance from the optical axis. Therefore, it is favorable for reducing impacts caused by the stray light from various incident directions. Specifically, the first angle formed between the first light blocking surface and the optical axis is not constant.

Moreover, the first light blocking surface faces towards the optical element, the first light blocking surface can include a reverse inclined portion, and the reverse inclined portion is gradually away from the optical element in a direction away from the optical axis. Therefore, it is favorable for guiding the stray light to the outside of the reflective element.

The first angle is formed between the reverse inclined portion and the optical axis, when the first angle is ea, the following condition can be satisfied: −0.5≤cos θa<0.

The protruding structures are arranged in an array in a direction away from the optical axis. On the section coinciding with the optical axis, the top of one of the protruding structures closest to the optical axis is taken as a reference point, when a distance between the reference point and the optical axis and in a direction perpendicular to the optical axis is X, and a distance between the reference point and the optical element faced by the first light blocking surface and in a direction parallel to the optical axis is Y2, the following condition can be satisfied: 0.03<Y2/X<0.76. When the arrangement of the protruding structures meets the condition, it is favorable for the stray light entering the light trap structure formed by the protruding structures arranged in the two-dimensional array, so that the effect of reducing the stray light can be improved.

The protruding structures can be further arranged in an array in a direction surrounding the optical axis. Therefore, it is favorable for reducing the stray light incident from various directions by the protruding structures arranged in the two-dimensional array and improving the effect of the light trap structure in destroying the stray light.

When a height of each of the protruding structures is H, the following condition can be satisfied: 6 μm<H<102 μm. Therefore, the light trap structure is with a sufficient ability to trap the stray light. Specifically, when the first light blocking surface is an inclined surface, the height of each of the protruding structures is calculated according to a central axis of each of the protruding structures.

When the height of each of the protruding structures is H, and a height difference between adjacent two of the protruding structures on the section coinciding with the optical axis is ΔH, the following condition can be satisfied: 0.05<ΔH/H<0.55. In detail, an appropriate ratio of the height difference to the height is favorable for trapping the stray light.

A distance between adjacent two of the protruding structures is greater than the height of each of the protruding structures. Therefore, it is favorable for the stray light reflecting between the protruding structures so as to reduce the stray light. Specifically, the distance between adjacent two of the protruding structures is calculated according to central axes of the adjacent two of the protruding structures.

The light blocking element can further include a second light blocking surface, the second light blocking surface can include a plurality of strip structures, the strip structures are arranged in an array in a direction surrounding the optical axis, and a cross-section of each of the strip structures is triangular. Therefore, it is favorable for reducing stray lights with different types.

On the section coinciding with the optical axis, a second angle is formed between the second light blocking surface and the optical axis, when the second angle is θb, the following condition can be satisfied: 0.5<cos θb<1. In detail, when the second angle formed between the second light blocking surface and the optical axis is too small to dispose the protruding structures, the strip structures is favorable for avoiding the stray light generating on the second light blocking surface. Specifically, the combination of the reverse inclined portion and the second light blocking surface can form a groove-like structure. Moreover, the light blocking element with the reverse inclined portion can be designed with the second light blocking surface so that an abutting mechanism of the light blocking element can be easily designed to abut other elements.

Each of the aforementioned features of the imaging lens assembly can be utilized in various combinations for achieving the corresponding effects.

The present disclosure provides an electronic device, which includes the aforementioned imaging lens assembly.

According to the aforementioned embodiment, specific examples are provided, and illustrated via figures.

### 1st Embodiment

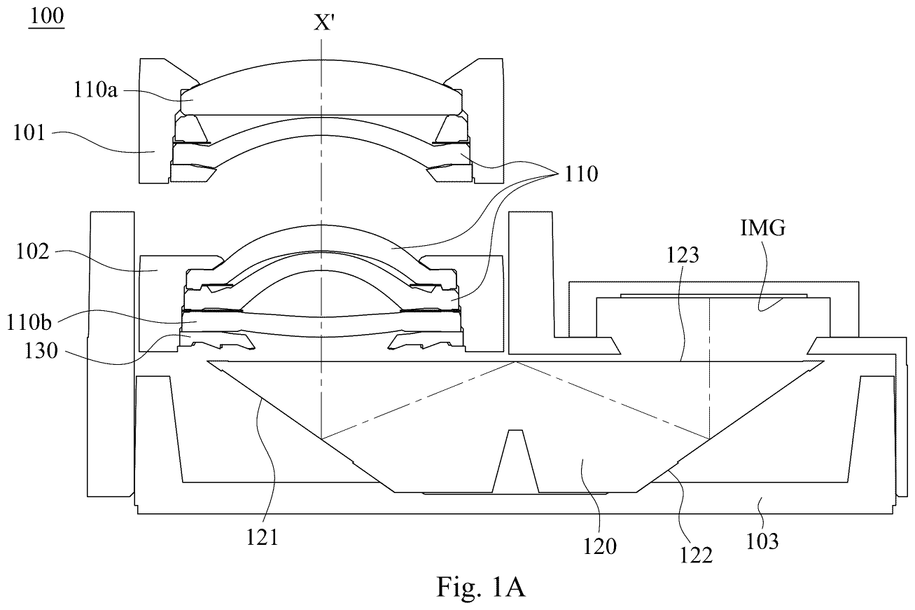

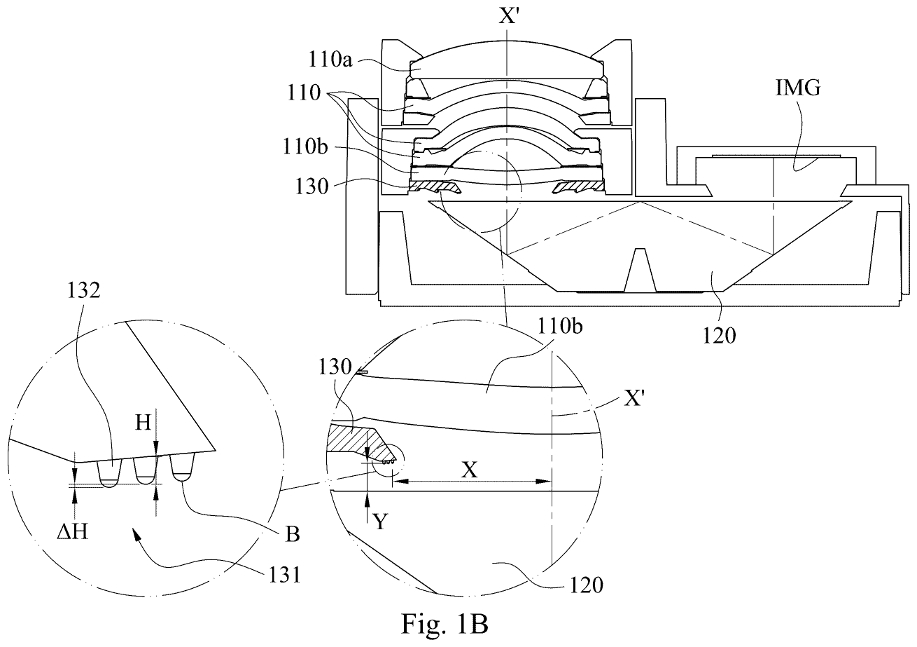

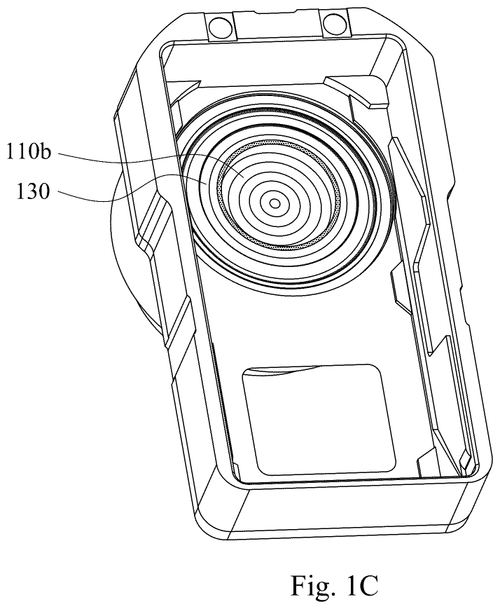

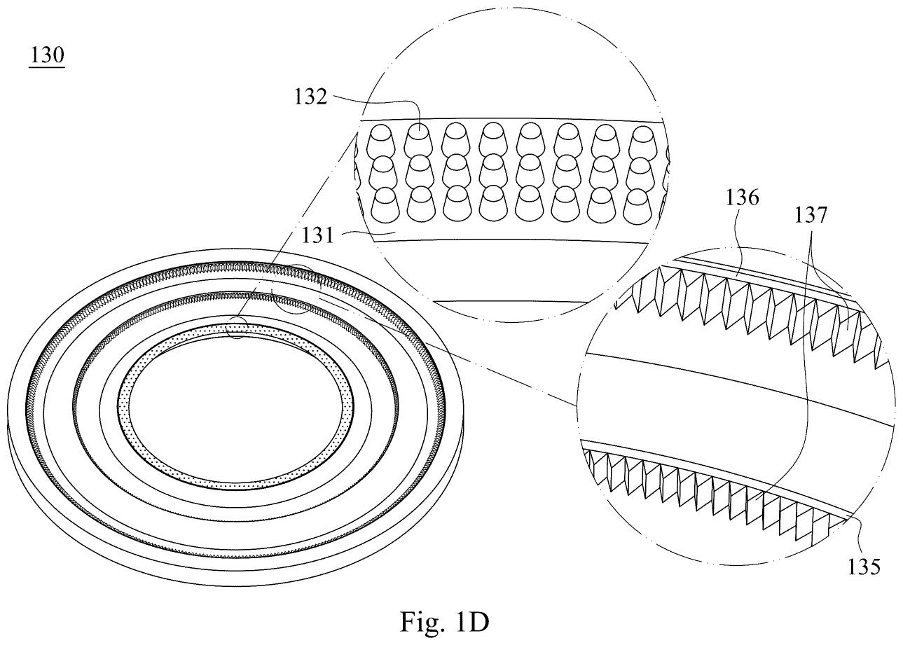

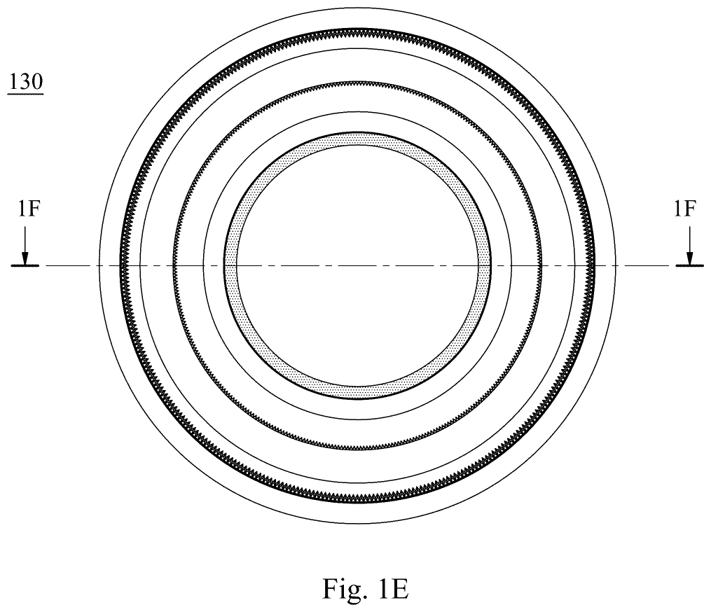

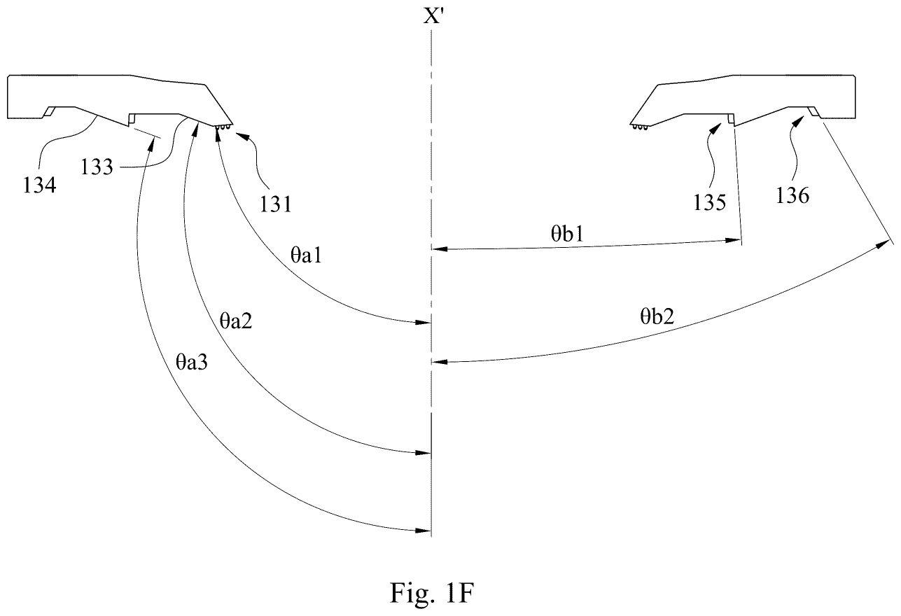

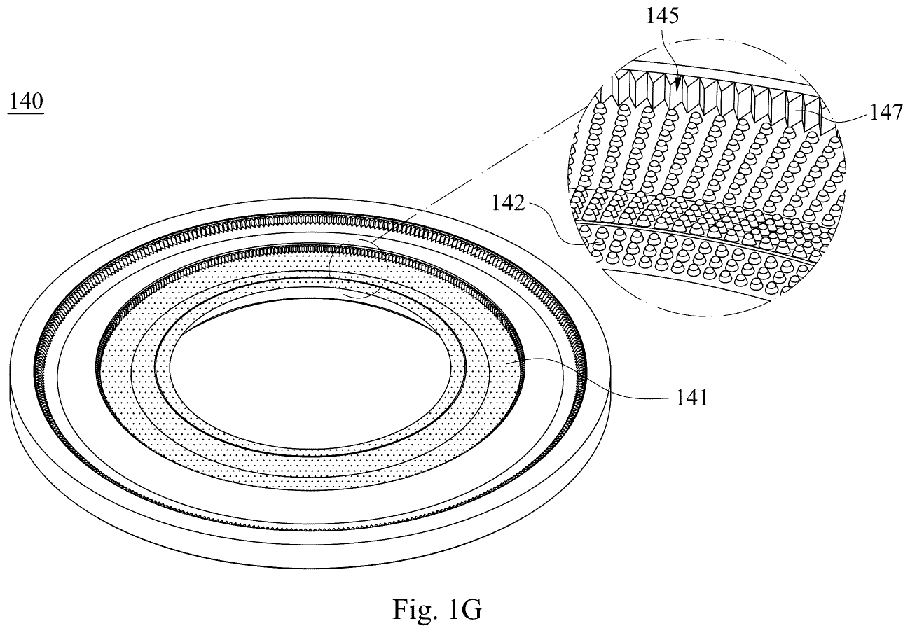

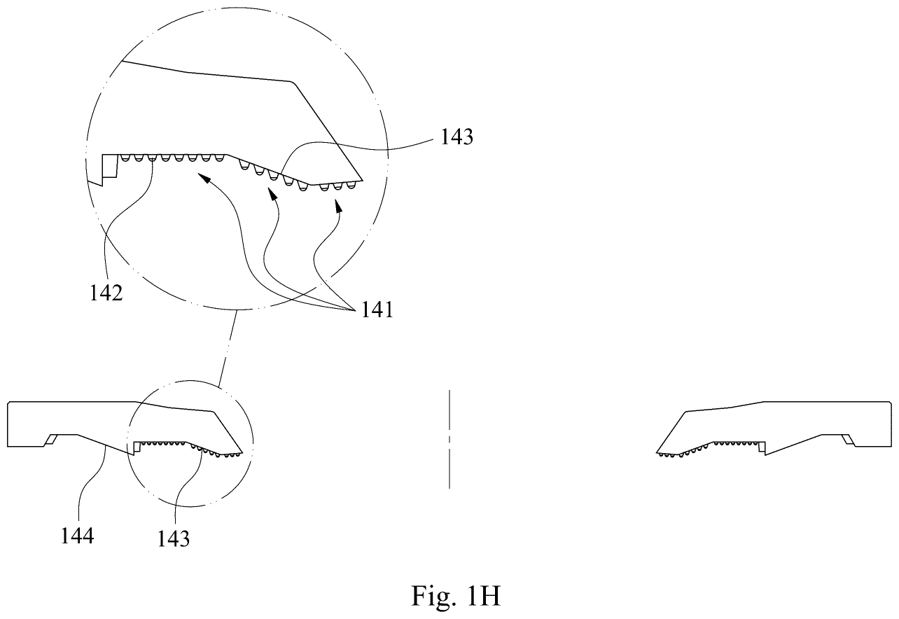

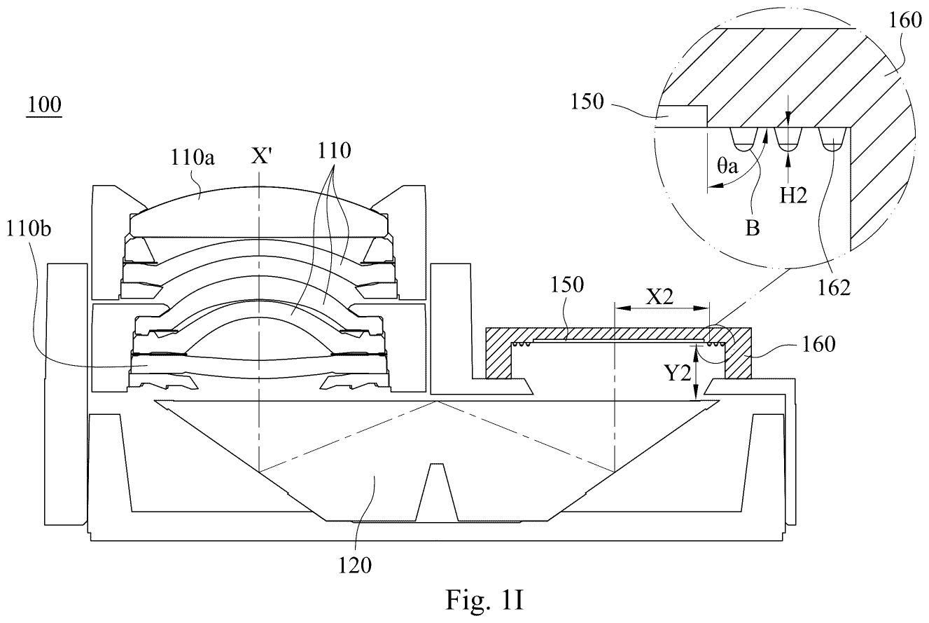

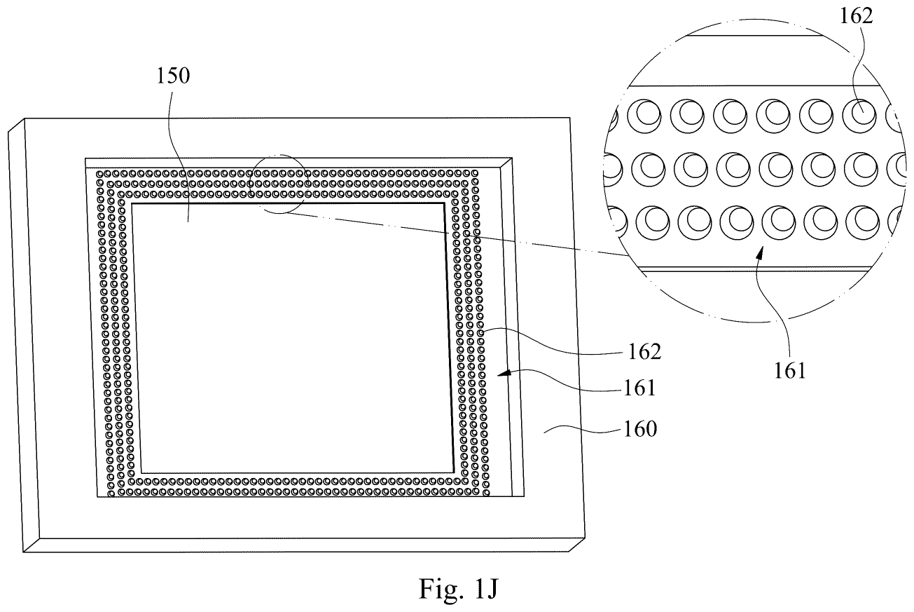

FIG. 1A is a schematic view of an imaging lens assembly 100 according to the 1st Example of the 1st Embodiment of the present disclosure, FIG. 1B is a partial enlarged view of the imaging lens assembly 100 according to the 1st Example of the 1st Embodiment in FIG. 1A, and FIG. 1C is a three-dimensional view of a lens element 110b and a light blocking element 130 according to the 1st Example of the 1st Embodiment in FIG. 1A. In FIG. 1A to FIG. 1C, the imaging lens assembly 100 has an optical axis X′ and includes a plurality of lens elements 110a, 110, 110b, a reflective element 120 and a light blocking element 130, and the optical axis X′ passes through the lens elements 110a, 110, 110b. The lens elements 110a, 110, 110b are respectively disposed in a first lens barrel 101 and a second lens barrel 102 and along the optical axis X′ from an object side of the imaging lens assembly 100 to an image side of the imaging lens assembly 100. The light blocking element 130 is disposed on a most image side of the second lens barrel 102. The reflective element 120 is disposed on an image side of the lens element 110b, and includes at least one reflecting surface. Specifically, the reflective element 120 is disposed between the lens elements 110a, 110, 110b and an image surface IMG through a third lens barrel 103. Furthermore, a distance between two of the lens elements 110a, 110, 110b is variable. In detail, the lens element 110a can be a ground glass lens element, the lens element 110b can be a plastic lens element, the light blocking element 130 can be a retainer, and the other lens element 110 can be a ground glass lens element or a plastic lens element according to requirements, but are not limited thereto.

Reflecting surfaces of the reflective element 120 can be a first reflecting surface 121, a second reflecting surface 122 and a third reflecting surface 123, and all of the reflecting surfaces 121, 122, 123 are configured to fold the optical axis X′. Moreover, the first reflecting surface 121 is configured to fold the optical axis X′ firstly, the third reflecting surface 123 is configured to fold the optical axis X′ secondly, and the second reflecting surface 122 is configured to fold the optical axis X′ thirdly. The reflective element 120 can further include an incident surface (its reference numeral is omitted) and an exit surface (its reference numeral is omitted), the optical axis X′ enters the reflective element 120 through the incident surface, and the optical axis X′ exits the reflective element 120 through the exit surface, wherein the incident surface and the exit surface are the same surface, and the third reflecting surface 123, the incident surface and the exit surface are coplanar.

The light blocking element 130 is opaque, the light blocking element 130 is disposed corresponding to the reflective element 120, and the light blocking element 130 includes a first light blocking surface 131 and a plurality of protruding structures 132. The first light blocking surface 131 is disposed between the lens element 110b and the reflective element 120.

In FIG. 1B, the protruding structures 132 are arranged in an array in a direction away from the optical axis X′. On a section coinciding with the optical axis X′, a top of one of the protruding structures 132 closest to the optical axis X′ is taken as a reference point B, a distance between the reference point B and the optical axis X′ and in a direction perpendicular to the optical axis X′ is X, and a distance between the reference point B and the reflective element 120 faced by the first light blocking surface 131 and in a direction parallel to the optical axis X′ is Y. In the 1st Example of the 1st Embodiment, X=1.51 mm, Y=0.26 mm, and Y/X=0.17.

A height of each of the protruding structures 132 is H, and a height difference between adjacent two of the protruding structures 132 on the section coinciding with the optical axis X′ is AH. In the 1st Example of the 1st Embodiment, H=30 μm, ΔH=3.5 μm, and ΔH/H=0.12. Furthermore, a distance between adjacent two of the protruding structures 132 is greater than the height H of each of the protruding structures 132. Specifically, the distance between adjacent two of the protruding structures 132 is calculated according to central axes of the adjacent two of the protruding structures 132.

FIG. 1D is a partial enlarged view of the light blocking element 130 according to the 1st Example of the 1st Embodiment in FIG. 1A, FIG. 1E is a schematic view of the light blocking element 130 according to the 1st Example of the 1st Embodiment in FIG. 1D, and FIG. 1F is a cross-sectional view of the light blocking element 130 along a cross line 1F-1F according to the 1st Example of the 1st Embodiment in FIG. 1E. In FIG. 1B, FIG. 1D to FIG. 1E, the protruding structures 132 are disposed on the first light blocking surface 131 and arranged in a two-dimensional array, the protruding structures 132 and the first light blocking surface 131 are formed integrally, a section of a bottom of each of the protruding structures 132 is circular, wherein each of the protruding structures 132 protrudes from the bottom in a direction away from the first light blocking surface 131 to form an arc surface on the top of each of the protruding structures 132. Moreover, the protruding structures 132 can be further arranged in an array in a direction surrounding the optical axis X′. Specifically, the two-dimensional array can be a linear array, a curved array, a circular array, etc., and a light trap structure can be formed by the protruding structures 132 arranged in the two-dimensional array, but are not limited thereto.

In FIG. 1B and FIG. 1F, on the section coinciding with the optical axis X′, first angles are formed between the first light blocking surface 131 and the optical axis X′, and the first angles are θa1, θa2 and θa3. In the 1st Example of the 1st Embodiment, θa1=85°, θa2=110°, θa3=110°, and sin θa1=0.996, sin θa2=0.94, sin θa3=0.94, cos θa2=−0.342, cos θa3=−0.342. Furthermore, the first angles θa1, θa2 and θa3 formed between the first light blocking surface 131 and the optical axis X′ can change with a distance from the optical axis X′.

Further, the first light blocking surface 131 faces towards the reflective element 120, the first light blocking surface 131 can include two reverse inclined portions 133, 134, and the reverse inclined portions 133, 134 are gradually away from the reflective element 120 in a direction away from the optical axis X′.

The light blocking element 130 can further include two second light blocking surfaces 135, 136, the second light blocking surfaces 135, 136 can include a plurality of strip structures 137, the strip structures 137 are arranged in an array in a direction surrounding the optical axis X′, and a cross-section of each of the strip structures 137 is triangular. Moreover, on the section coinciding with the optical axis X′, second angles are formed between the second light blocking surfaces 135, 136 and the optical axis X′, the second angles are θb1, θb2. In the 1st Example of the 1st Embodiment, θb1=3.6°, θb2=30°, and cos θb1=0.998, cos θb2=0.866.

FIG. 1G is a partial enlarged view of a light blocking element 140 according to the 2nd Example of the 1st Embodiment of the present disclosure, and FIG. 1H is a cross-sectional view of the light blocking element 140 according to the 2nd Example of the 1st Embodiment in FIG. 1G. Structures, positions and connection relationships of the elements according to the 2nd Example of the 1st Embodiment are the same or similar to the elements according to the 1st Example of the 1st Embodiment, and the difference is that the light blocking element 140 according to the 2nd Example of the 1st Embodiment includes first light blocking surfaces 141 and a plurality of protruding structures 142, wherein the first light blocking surfaces 141 can further include two reverse inclined portions 143, 144. Moreover, the light blocking element 140 can further include a second light blocking surface 145, the second light blocking surface 145 can include a plurality of strip structures 147, the strip structures 147 are arranged in an array in a direction surrounding the optical axis X′, and a cross-section of each of the strip structures 147 is triangular. In detail, the protruding structures 142 of the light blocking element 140 can be further disposed on one of the first light blocking surfaces 141 on the reverse inclined portion 143 and on the other of the first light blocking surfaces 141 between the second light blocking surface 145 and the reverse inclined portion 143.

The structures, positions and connection relationships of the other elements according to the 2nd Example of the 1st Embodiment are the same as the elements according to the 1st Example of the 1st Embodiment, and will not describe again herein.

FIG. 1I is a partial enlarged view of the imaging lens assembly 100 according to the 3rd Example of the 1st Embodiment of the present disclosure, and FIG. 1J is a schematic view of an image sensor 150 and a light blocking element 160 according to the 3rd Example of the 1st Embodiment in FIG. 1I. In FIG. 1I and FIG. 1J, structures, positions and connection relationships of the elements according to the 3rd Example of the 1st Embodiment are the same or similar to the elements according to the 1st Example of the 1st Embodiment, and the difference is that the image sensor 150 of the imaging lens assembly 100 according to the 3rd Example of the 1st Embodiment is disposed in a light blocking element 160 and corresponds to the reflective element 120, and the light blocking element 160 corresponds to the reflective element 120. In detail, the reflective element 120 is translucent, the image sensor 150 is configured to sense a light. The light blocking element 160 includes a first light blocking surface 161 and a plurality of protruding structures 162. The first light blocking surface 161 is disposed between the reflective element 120 and the image sensor 150. The protruding structures 162 are disposed on the first light blocking surface 161 and arranged in a two-dimensional array, the protruding structures 162 and the first light blocking surface 161 are formed integrally, and a section of a bottom of each of the protruding structures 162 is circular, wherein each of the protruding structures 162 protrudes from the bottom in a direction away from the first light blocking surface 161 to form an arc surface on a top of each of the protruding structures 162. Further, the protruding structures 162 can be further arranged in an array in a direction surrounding the optical axis X′. Specifically, the light blocking element 160 can be an image sensor base, and is not limited thereto.

In FIG. 1I, on a section coinciding with the optical axis X′, a first angle is formed between the first light blocking surface 161 and the optical axis X′, and the first angle is θa. In the 3rd Example of the 1st Embodiment, θa=90°, and sin θa=1. Furthermore, the first angles θa formed between the first light blocking surface 161 and the optical axis X′ can change with a distance from the optical axis X′.

The protruding structures 162 are arranged in an array in a direction away from the optical axis X′. On the section coinciding with the optical axis X′, a top of one of the protruding structures 162 closest to the optical axis X′ is taken as a reference point B, a distance between the reference point B and the optical axis X′ and in a direction perpendicular to the optical axis X′ is X2, and a distance between the reference point B and the reflective element 120 faced by the first light blocking surface 161 and in a direction parallel to the optical axis X′ is Y2. In the 3rd Example of the 1st Embodiment, X2=2.3 mm, Y2=1.32 mm, and Y2/X2=0.57. Moreover, a height of each of the protruding structures 162 is H2. In the 3rd Example of the 1st Embodiment, H2=85 μm. Furthermore, a distance between adjacent two of the protruding structures 162 is greater than the height H2 of each of the protruding structures 162. Specifically, the distance between adjacent two of the protruding structures 162 is calculated according to central axes of the adjacent two of the protruding structures 162.

The structures, positions and connection relationships of the other elements according to the 3rd Example of the 1st Embodiment are the same as the elements according to the 1st Example of the 1st Embodiment, and will not describe again herein.

### 2nd Embodiment

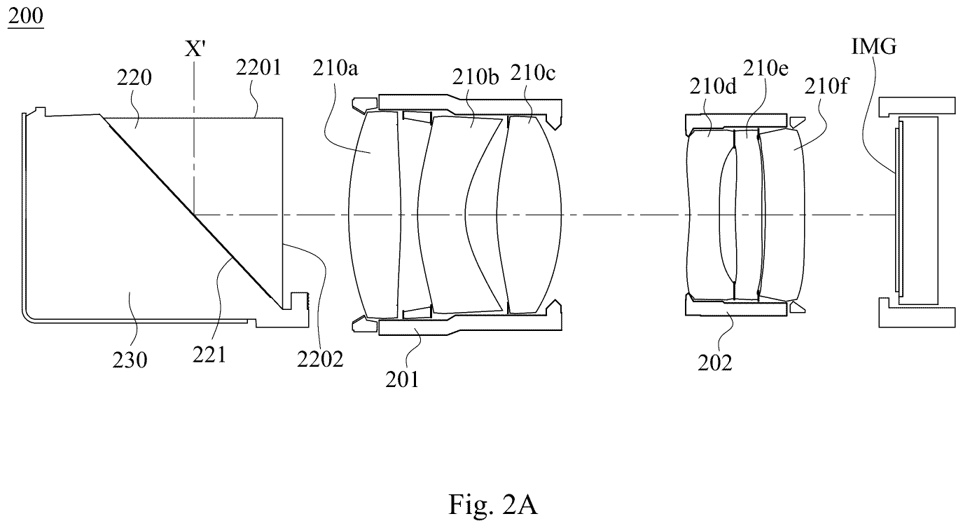

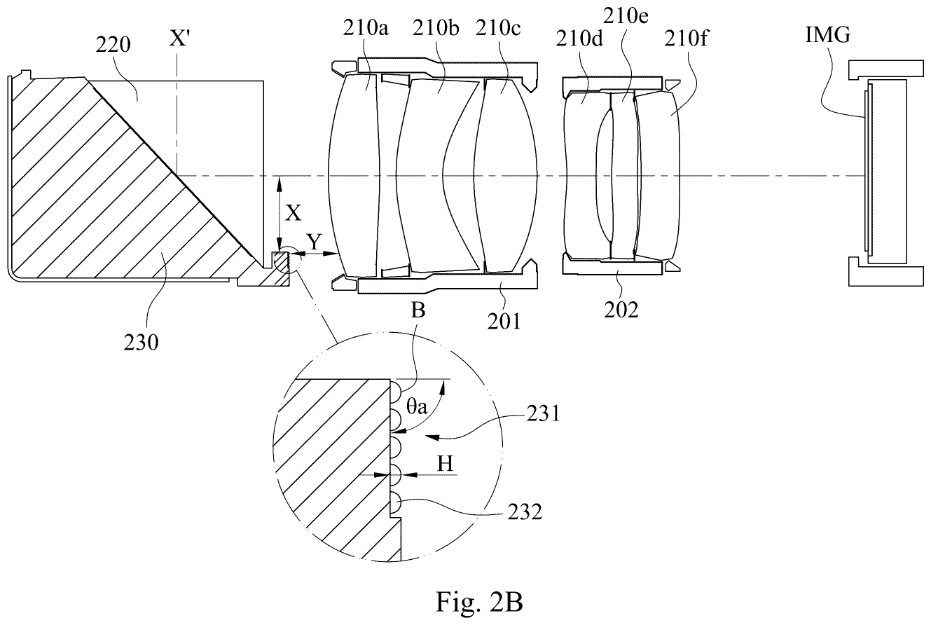

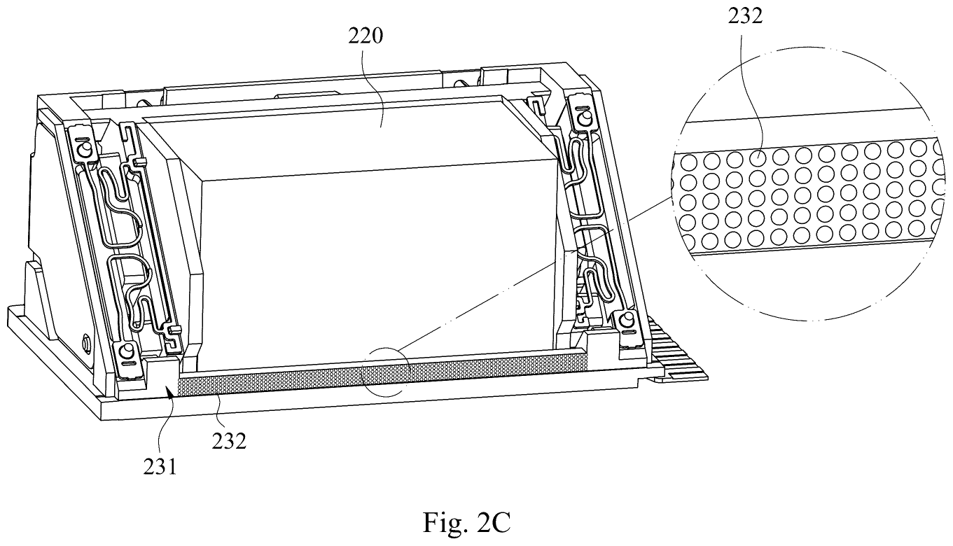

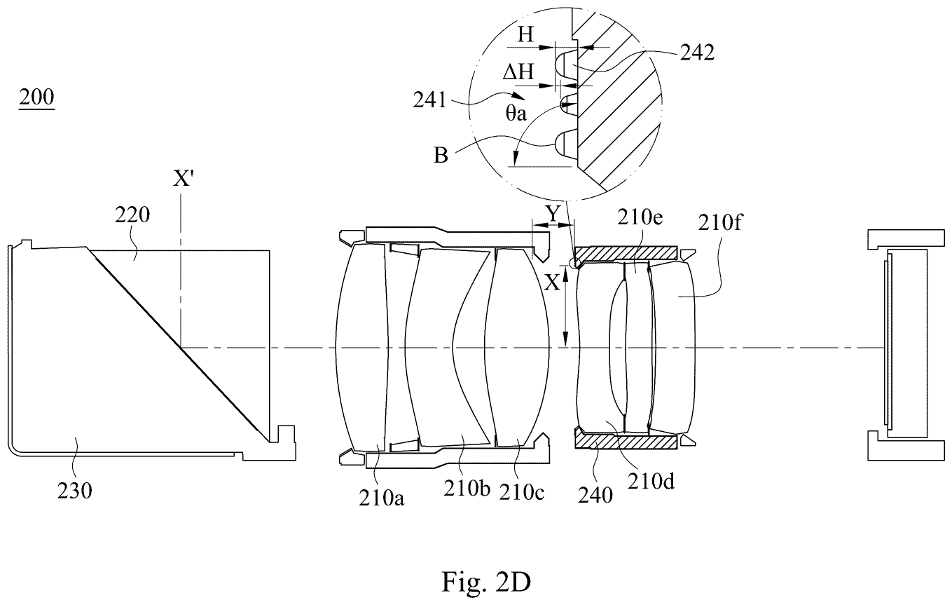

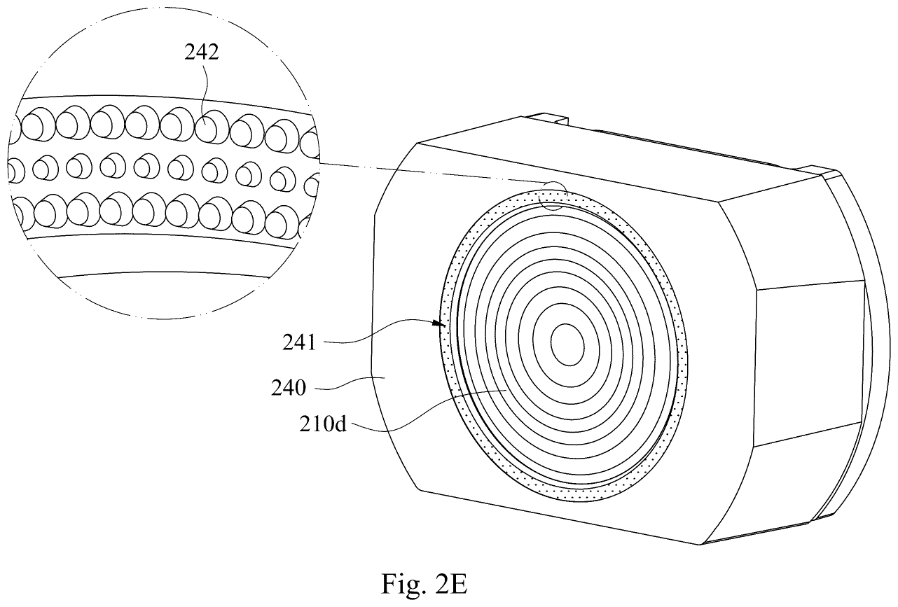

FIG. 2A is a schematic view of an imaging lens assembly 200 according to the 1st Example of the 2nd Embodiment of the present disclosure, FIG. 2B is a partial enlarged view of the imaging lens assembly 200 according to the 1st Example of the 2nd Embodiment in FIG. 2A, and FIG. 2C is a partial three-dimensional view of the imaging lens assembly 200 according to the 1st Example of the 2nd Embodiment in FIG. 2A. In FIG. 2A to FIG. 2C, the imaging lens assembly 200 has an optical axis X′ and includes a plurality of lens elements 210a, 210b, 210c, 210d, 210e, 210f, a reflective element 220 and a light blocking element 230, and the optical axis X′ passes through the lens elements 210a, 210b, 210c, 210d, 210e, 210f. The lens elements 210a, 210b, 210c, 210d, 210e, 210f are respectively disposed in a first lens barrel 201 and a second lens barrel 202 and along the optical axis X′ from an object side of the imaging lens assembly 200 to an image side of the imaging lens assembly 200. The reflective element 220 is disposed on an object side of the lens element 210a, and includes a first reflecting surface 221. The first reflecting surface 221 is configured to fold the optical axis X′. The reflective element 220 can further include an incident surface 2201 and an exit surface 2202, the optical axis X′ enters the reflective element 220 through the incident surface 2201, and the optical axis X′ exits the reflective element 220 through the exit surface 2202. Furthermore, an image surface IMG is on an image side of the lens element 210f. Specifically, the lens element 210a can be a molding glass lens element, the other lens elements 210b, 210c, 210d, 210e, 210f can be independently a ground glass lens element or a plastic lens element according to requirements, and the light blocking element 230 can be a reflective element bracket, but are not limited thereto. Further, a distance between two of the lens elements 210a, 210b, 210c, 210d, 210e, 210f is variable.

The light blocking element 230 is opaque, the light blocking element 230 is disposed corresponding to the lens element 210a, and the light blocking element 230 includes a first light blocking surface 231 and a plurality of protruding structures 232. The first light blocking surface 231 is disposed between the lens element 210a and the reflective element 220.

In FIG. 2B and FIG. 2C, the protruding structures 232 are disposed on the first light blocking surface 231 and arranged in a two-dimensional array, the protruding structures 232 and the first light blocking surface 231 are formed integrally, and each of the protruding structures 232 protrudes from a bottom in a direction away from the first light blocking surface 231.

On a section coinciding with the optical axis X′, a first angle is formed between the first light blocking surface 231 and the optical axis X′, and the first angle is Oa. In the 1st Example of the 2nd Embodiment, θa=90°, and sin θa=1. Furthermore, the first angle θa formed between the first light blocking surface 231 and the optical axis X′ can change with a distance from the optical axis X′.

The protruding structures 232 are arranged in an array in a direction away from the optical axis X′. On the section coinciding with the optical axis X′, a top of one of the protruding structures 232 closest to the optical axis X′ is taken as a reference point B, a distance between the reference point B and the optical axis X′ and in a direction perpendicular to the optical axis X′ is X, and a distance between the reference point B and the lens element 210a faced by the first light blocking surface 231 and in a direction parallel to the optical axis X′ is Y. In the 1st Example of the 2nd Embodiment, X=2.44 mm, Y=1.56 mm, and Y/X=0.64. Moreover, a height of each of the protruding structures 232 is H. In the 1st Example of the 2nd Embodiment, H=40 μm. Furthermore, a distance between adjacent two of the protruding structures 232 is greater than the height H of each of the protruding structures 232. Specifically, the distance between adjacent two of the protruding structures 232 is calculated according to central axes of the adjacent two of the protruding structures 232.

FIG. 2D is a schematic view of the imaging lens assembly 200 according to the 2nd Example of the 2nd Embodiment of the present disclosure, and FIG. 2E is a three-dimensional view of the lens element 210d and a light blocking element 240 according to the 2nd Example of the 2nd Embodiment in FIG. 2D. In FIG. 2D and FIG. 2E, structures, positions and connection relationships of the elements according to the 2nd Example of the 2nd Embodiment are the same or similar to the elements according to the 1st Example of the 2nd Embodiment, and the difference is that the lens elements 210d, 210e, 210f of the imaging lens assembly 200 according to the 2nd Example of the 2nd Embodiment are disposed in the light blocking element 240. Specifically, the light blocking element 240 can be a barrel, but is not limited thereto.

The light blocking element 240 is opaque, and the light blocking element 240 includes a first light blocking surface 241 and a plurality of protruding structures 242. The first light blocking surface 241 is disposed between the lens element 210c and the lens element 210d.

The protruding structures 242 are disposed on the first light blocking surface 241 and arranged in a two-dimensional array, the protruding structures 242 and the first light blocking surface 241 are formed integrally, and a section of a bottom of each of the protruding structures 242 is circular, wherein each of the protruding structures 242 protrudes from the bottom in a direction away from the first light blocking surface 241 to form an arc surface on a top of each of the protruding structures 242. The protruding structures 242 can be further arranged in an array in a direction surrounding the optical axis X′. Specifically, a light trap structure can be formed by the protruding structures 242 arranged in the two-dimensional array, but are not limited thereto.

The protruding structures 242 are arranged in an array in a direction away from the optical axis X′. On the section coinciding with the optical axis X′, the top of one of the protruding structures 242 closest to the optical axis X′ is taken as a reference point B, a distance between the reference point B and the optical axis X′ and in a direction perpendicular to the optical axis X′ is X, and a distance between the reference point B and the lens element 210c faced by the first light blocking surface 241 and in a direction parallel to the optical axis X′ is Y. In the 2nd Example of the 2nd Embodiment, X=2.51 mm, Y=1.29 mm, and Y/X=0.51. Moreover, a height of each of the protruding structures 242 is H, and a height difference between adjacent two of the protruding structures 242 on the section coinciding with the optical axis X′ is ΔH. In the 2nd Example of the 2nd Embodiment, H=40 μm, ΔH=10 μm, and ΔH/H=0.25. A distance between adjacent two of the protruding structures 242 is greater than the height H of each of the protruding structures 242. Specifically, the distance between adjacent two of the protruding structures 242 is calculated according to central axes of the adjacent two of the protruding structures 242.

On the section coinciding with the optical axis X′, a first angle is formed between the first light blocking surface 241 and the optical axis X′, and the first angle is θa. In the 2nd Example of the 2nd Embodiment, θa=90°, and sin θa=1. The first angle θa formed between the first light blocking surface 241 and the optical axis X′ can change with a distance from the optical axis X′.

The structures, positions and connection relationships of the other elements according to the 2nd Example of the 2nd Embodiment are the same as the elements according to the 1st Example of the 2nd Embodiment, and will not describe again herein.

### 3rd Embodiment

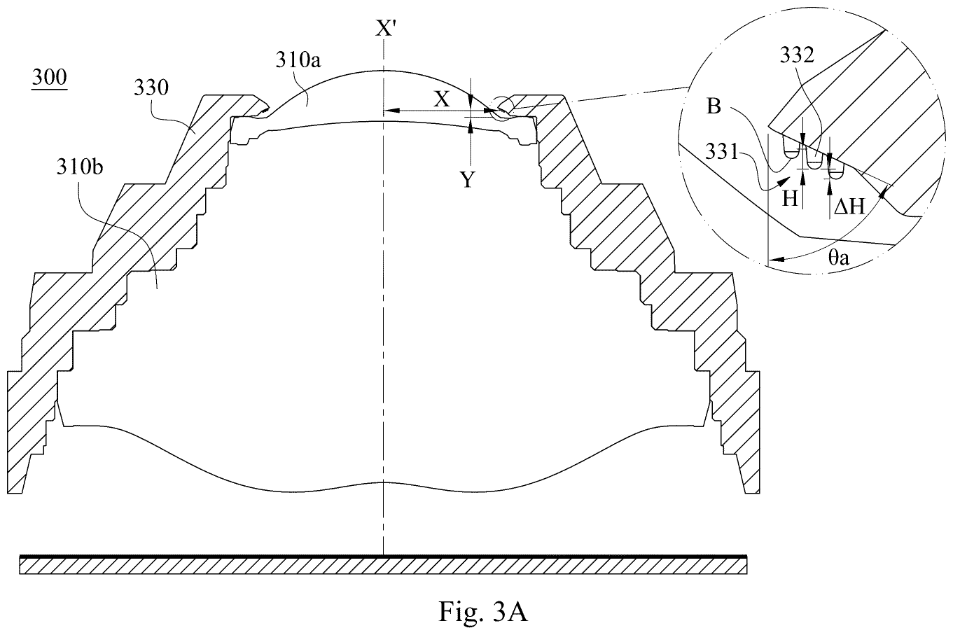

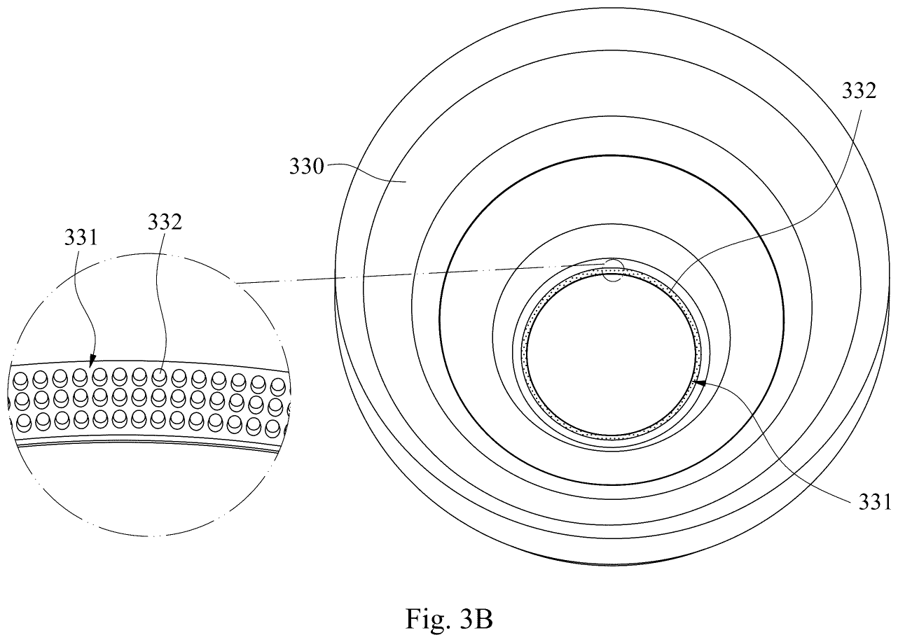

FIG. 3A is a schematic view of an imaging lens assembly 300 according to the 1st Example of the 3rd Embodiment of the present disclosure, and FIG. 3B is a partial enlarged view of a light blocking element 330 according to the 1st Example of the 3rd Embodiment in FIG. 3A. In FIG. 3A and FIG. 3B, the imaging lens assembly 300 has an optical axis X′ and includes a plurality of lens elements 310a, 310b and a light blocking element 330, and the optical axis X′ passes through the lens elements 310a, 310b. The lens elements 310a, 310b are disposed in the light blocking element 330 and along the optical axis X′ from an object side of the imaging lens assembly 300 to an image side of the imaging lens assembly 300.

The light blocking element 330 is opaque, and the light blocking element 330 includes a first light blocking surface 331 and a plurality of protruding structures 332. The first light blocking surface 331 faces towards an image side, and the first light blocking surface 331 is disposed adjacent to the lens element 310a. The protruding structures 332 are disposed on the first light blocking surface 331 and arranged in a two-dimensional array, the protruding structures 332 and the first light blocking surface 331 are formed integrally, a section of a bottom of each of the protruding structures 332 is circular, wherein each of the protruding structures 332 protrudes from the bottom in a direction away from the first light blocking surface 331 to form an arc surface on a top of each of the protruding structures 332. Moreover, the protruding structures 332 can be further arranged in an array in a direction surrounding the optical axis X′.

On a section coinciding with the optical axis X′, a first angle is formed between the first light blocking surface 331 and the optical axis X′, and the first angle is θa. In the 1st Example of the 3rd Embodiment, θa=65°, and sin θa=0.906. Furthermore, the first angle θa formed between the first light blocking surface 331 and the optical axis X′ can change with a distance from the optical axis X′.

The protruding structures 332 are arranged in an array in a direction away from the optical axis X′. On the section coinciding with the optical axis X′, the top of one of the protruding structures 332 closest to the optical axis X′ is taken as a reference point B, a distance between the reference point B and the optical axis X′ and in a direction perpendicular to the optical axis X′ is X, and a distance between the reference point B and the lens element 310a faced by the first light blocking surface 331 and in a direction parallel to the optical axis X′ is Y. In the 1st Example of the 3rd Embodiment, X=2.58 mm, Y=0.15 mm, and Y/X=0.06. A height of each of the protruding structures 332 is H, and a height difference between adjacent two of the protruding structures 332 on the section coinciding with the optical axis X′ is ΔH. In the 1st Example of the 3rd Embodiment, H=40 μm, Δ=20 μm, and Δ/H=0.5. A distance between adjacent two of the protruding structures 332 is greater than the height H of each of the protruding structures 332.

### 4th Embodiment

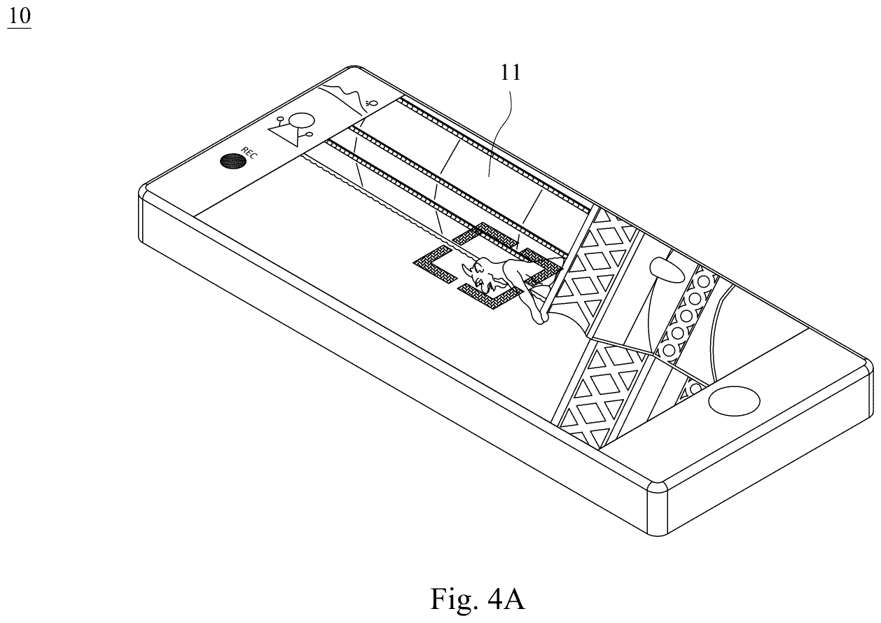

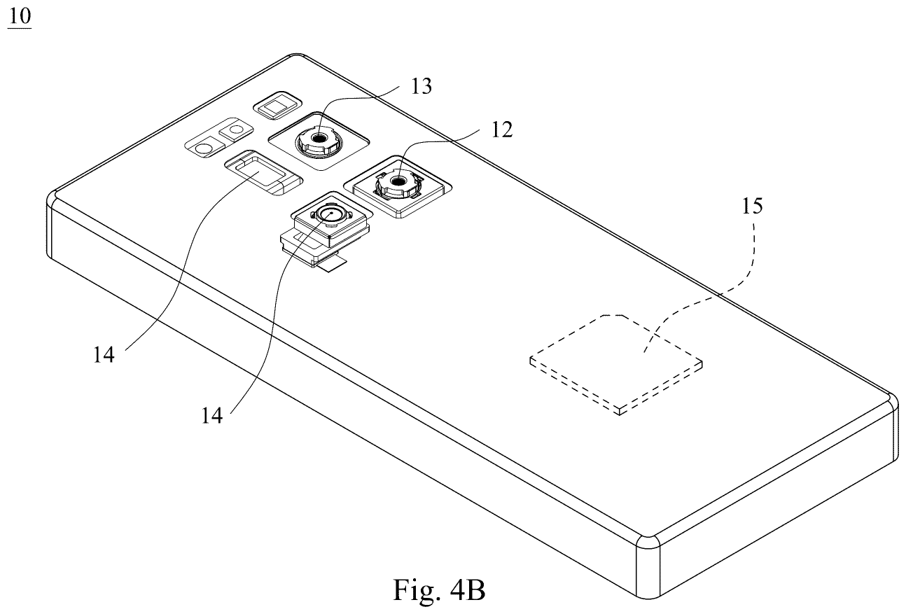

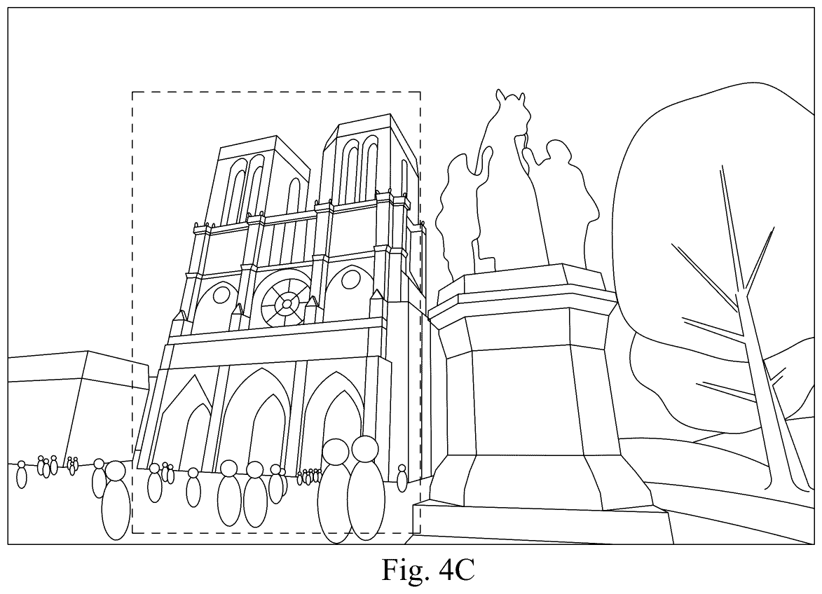

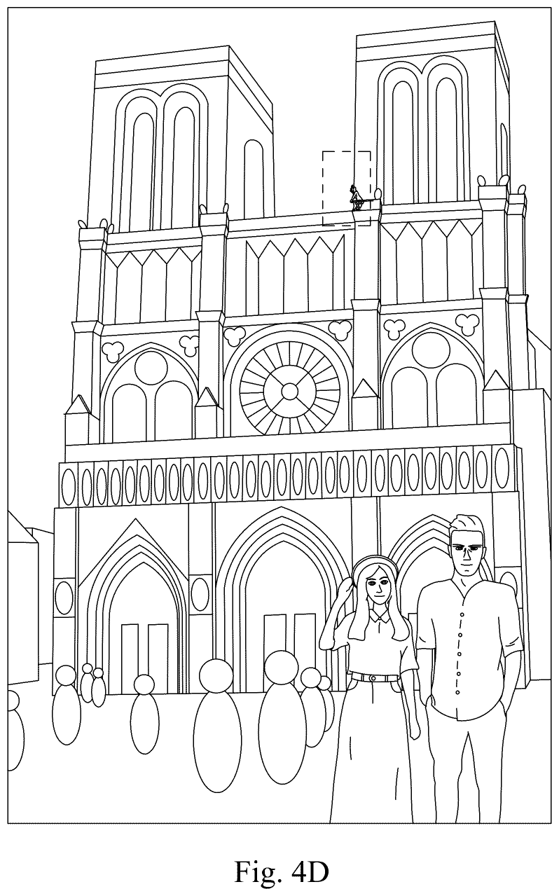

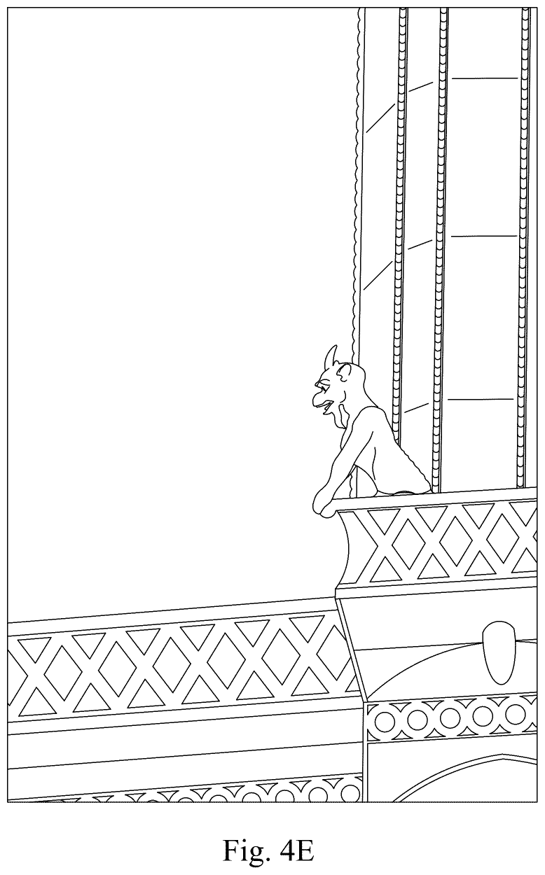

FIG. 4A is a schematic view of an electronic device 10 according to the 4th Embodiment of the present disclosure, and FIG. 4B is another schematic view of the electronic device 10 according to the 4th Embodiment in FIG. 4A. In FIG. 4A and FIG. 4B, the electronic device 10 is a smart phone, and the electronic device 10 includes imaging lens assemblies and a user interface 11. The imaging lens assemblies are an ultra-wide angle imaging lens assembly 12, a high resolution imaging lens assembly 13 and a telephoto imaging lens assembly 14, and the user interface 11 is a touch screen, but the present disclosure is not limited thereto. Particularly, the imaging lens assembly can be the imaging lens assembly according to any one of the aforementioned 1st Embodiment to the 3rd Embodiment, but the present disclosure is not limited thereto.

A user enters a shooting mode via the user interface 11, wherein the user interface 11 is configured to display an image, and the shooting angle can be manually adjusted to switch to different imaging lens assemblies. At this moment, the imaging light is gathered on an image sensor via the imaging lens assembly, and an electronic signal about an image is output to an image signal processor (ISP) 15.

In FIG. 4B, in order to meet a camera specification of the electronic device 10, the electronic device 10 can further include an optical anti-shake mechanism (not shown). Furthermore, the electronic device 10 can further include at least one focusing assisting module (not shown) and at least one sensing element (not shown). The focusing assisting module can be a flash module (not shown) for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the imaging lens assembly of the electronic device 10 equipped with an auto-focusing mechanism and the optical anti-shake mechanism can be enhanced to achieve the superior image quality. Furthermore, the electronic device 10 according to the present disclosure can have a capturing function with multiple modes, such as taking optimized selfies, high dynamic range (HDR) under a low light condition, 4K resolution recording and so on. Furthermore, the user can visually see a captured image of the camera via the user interface 11 and manually operate the view finding range on the user interface 11 to achieve the autofocus function of what you see is what you get.

Moreover, the imaging lens assembly, the optical anti-shake mechanism, the sensing element and the focusing assisting module can be disposed on a flexible printed circuit board (FPC) (not shown) and electrically connected to the image signal processor 15 and other related components, via a connector (not shown) to perform a capturing process. Since the current electronic devices, such as smart phones, have a tendency of being compact, the way of firstly disposing the camera module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the imaging lens assembly can also be controlled more flexibly via the touch screen of the electronic device. According to the 4th Embodiment, the electronic device 10 can include a plurality of sensing elements and a plurality of focusing assisting modules. The sensing elements and the focusing assisting modules are disposed on the flexible printed circuit board and at least one other flexible printed circuit board (not shown) and electrically connected to the image signal processor 15 and other related components, via corresponding connectors to perform the capturing process. In other embodiments (not shown), the sensing elements and the focusing assisting modules can also be disposed on the main board of the electronic device or carrier boards of other types according to requirements of the mechanical design and the circuit layout.

Furthermore, the electronic device 10 can further include, but not be limited to, a display, a control unit, a storage unit, a random access memory (RAM), a read-only memory (ROM), or the combination thereof.

FIG. 4C is a schematic view of an image captured via the electronic device 10 according to the 4th Embodiment in FIG. 4A. In FIG. 4C, the larger range of the image can be captured via the ultra-wide angle imaging lens assembly 12, and the ultra-wide angle imaging lens assembly 12 has the function of accommodating wider range of the scene.

FIG. 4D is a schematic view of another image captured via the electronic device 10 according to the 4th Embodiment in FIG. 4A. In FIG. 4D, the image of the certain range with the high resolution can be captured via the high resolution imaging lens assembly 13, and the high resolution imaging lens assembly 13 has the function of the high resolution and the low deformation.

FIG. 4E is a schematic view of another image captured via the electronic device 10 according to the 4th Embodiment in FIG. 4A. In FIG. 4E, the telephoto imaging lens assembly 14 has the enlarging function of the high magnification, and the distant image can be captured and enlarged with high magnification via the telephoto imaging lens assembly 14.

In FIG. 4C to FIG. 4E, the zooming function can be obtained via the electronic device 10, when the scene is captured via the imaging lens assembly with different focal lengths cooperated with the function of image processing.

### 5th Embodiment

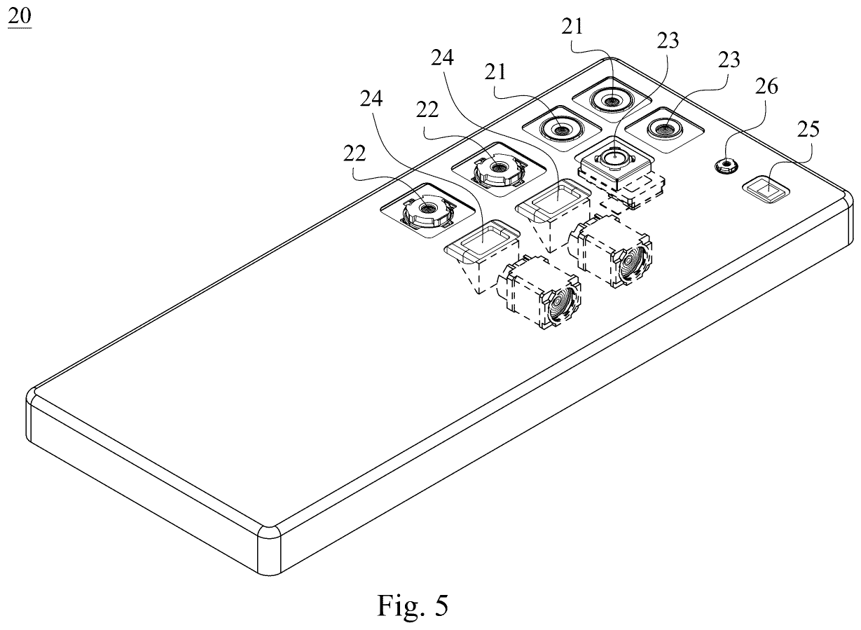

FIG. 5 is a schematic view of an electronic device 20 according to the 5th Embodiment of the present disclosure. In FIG. 5, the electronic device 20 is a smart phone, which includes imaging lens assemblies. Moreover, the imaging lens assemblies are ultra-wide angle imaging lens assemblies 21, wide angle imaging lens assemblies 22, telephoto imaging lens assemblies 23, 24 and a Time-Of-Flight (TOF) module 26. The TOF module 26 can be another type of the imaging lens assembly, and the disposition is not limited thereto. Particularly, the imaging lens assembly can be the imaging lens assembly according to any one of the aforementioned 1st Embodiment to the 3rd Embodiment, but the present disclosure is not limited thereto.

Furthermore, the telephoto imaging lens assemblies 24 are configured to fold the light, but the present disclosure is not limited thereto.

To meet a specification of the camera module of the electronic device 20, the electronic device 20 can further include an optical anti-shake mechanism (not shown). Furthermore, the electronic device 20 can further include at least one focusing assisting module (not shown) and at least one sensing element (not shown). The focusing assisting module can be a flash module 25 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the imaging lens assembly of the electronic device 20 equipped with an auto-focusing mechanism and the optical anti-shake mechanism can be enhanced to achieve the superior image quality. Furthermore, the electronic device 20 according to the present disclosure can have a capturing function with multiple modes, such as taking optimized selfies, High Dynamic Range (HDR) under a low light condition, 4K Resolution recording and so on.

Moreover, all of other component structures and dispositions according to the 5th Embodiment are the same as the component structures and the dispositions according to the 4th Embodiment, and will not be described again herein.

### 6th Embodiment

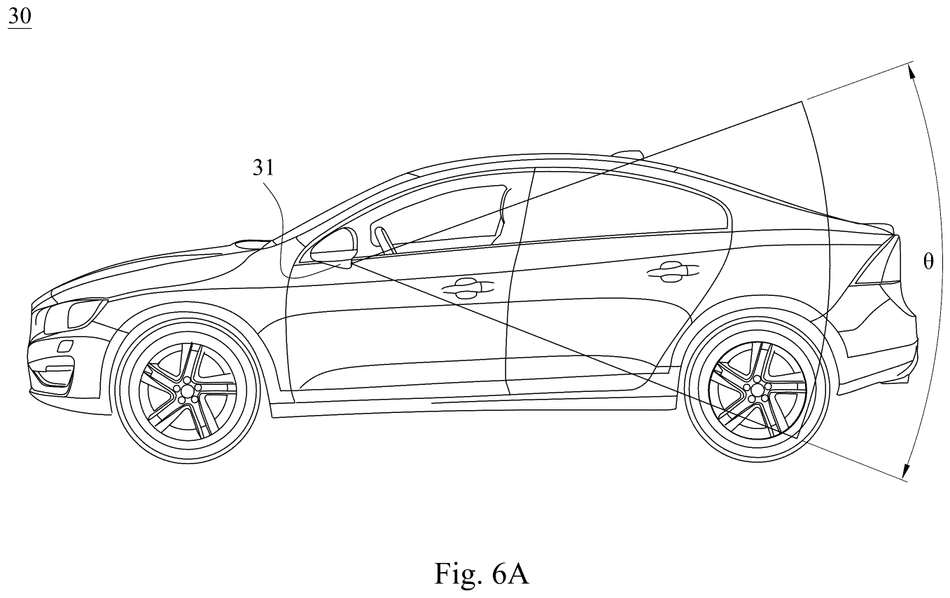

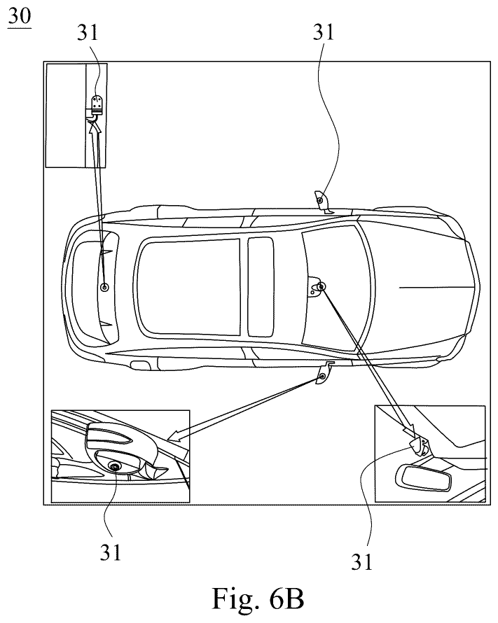

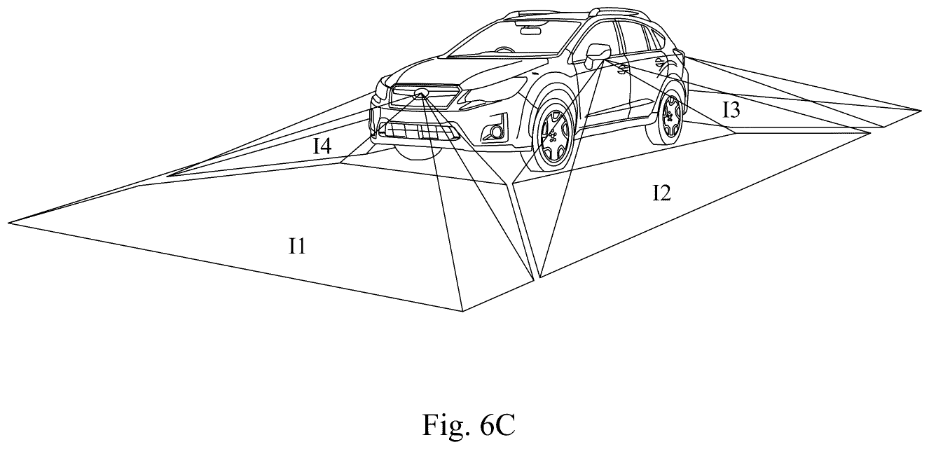

FIG. 6A is a schematic view of a vehicle instrument 30 according to the 6th Embodiment of the present disclosure, FIG. 6B is another schematic view of the vehicle instrument 30 according to the 6th embodiment in FIG. 6A, and FIG. 6C is another schematic view of the vehicle instrument 30 according to the 6th Embodiment in FIG. 6A. In FIG. 6A to FIG. 6C, an electronic device (not shown) is applied to the vehicle instrument 30, and the electronic device includes imaging lens assemblies 31. In the 6th Embodiment, a number of the imaging lens assemblies 31 is six, the imaging lens assemblies 31 are vehicle imaging lens assemblies, and the structures of the imaging lens assembly can be the imaging lens assembly according to any one of the aforementioned 1st Embodiment to the 3th Embodiment, but the present disclosure is not limited thereto.

In FIG. 6A to FIG. 6C, two of the imaging lens assemblies 31 are disposed below a left rearview mirror and a right rearview mirror, respectively, to capture the image information with a visual angle θ. Particularly, the visual angle θ can satisfy the following condition 40 degrees <θ<90 degrees. Therefore, the image information within a left lane and a right lane can be captured.

In FIG. 6A to FIG. 6C, another two of the imaging lens assemblies 31 can be disposed in an inner space of the vehicle instrument 30. Therefore, it is favorable to a driver to obtain the information of the outer space, such as external space informations I1, I2, I3, I4, but the present disclosure is not limited thereto. Particularly, the another two of the imaging lens assemblies 31 are disposed near a rearview mirror and near a rear window in the vehicle instrument 30 respectively. Moreover, the imaging lens assemblies 31 can be disposed on the non-mirror surfaces of the left rearview mirror and the right rearview mirror, respectively, but the present disclosure is not limited thereto.

The other two of the imaging lens assemblies 31 can be disposed at a front-end and a rear-end of the vehicle instrument 30, respectively, wherein the imaging lens assemblies 31 are disposed at a front-end and a rear-end of the vehicle instrument 30, and below the left rearview mirror and the right rearview mirror. Therefore, more visual angles can be provided to reduce the blind spot, so that the driving safety can be improved. Moreover, it is helpful to identify the traffic information out of the vehicle instrument 30 via disposing the imaging lens assemblies 31 around the vehicle instrument 30, which is favorable for realizing a function of autopilot driving.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly, having an optical axis, and comprising:
a lens element, wherein the optical axis passes through the lens element;
a reflective element disposed on an object side or an image side of the lens element, and comprising:
a first reflecting surface configured to fold the optical axis; and
a light blocking element, wherein the light blocking element is opaque, the light blocking element is disposed corresponding to the lens element or the reflective element, and the light blocking element comprises:
a first light blocking surface disposed between the lens element and the reflective element; and
a plurality of protruding structures disposed on the first light blocking surface and arranged in a two-dimensional array, wherein the protruding structures and the first light blocking surface are formed integrally, a section of a bottom of each of the protruding structures is circular, and each of the protruding structures protrudes from the bottom in a direction away from the first light blocking surface to form an arc surface on a top of each of the protruding structures;
wherein, on a section coinciding with the optical axis, a first angle is formed between the first light blocking surface and the optical axis, the first angle is θa, and the following condition is satisfied:
$$0.86 < sin θ a \leq 1.$$

2. The imaging lens assembly of claim 1, wherein the first angle is θa, and the following condition is satisfied:
$$0.96 < sin θ a \leq 1.$$

3. The imaging lens assembly of claim 1, wherein the first angle formed between the first light blocking surface and the optical axis changes with a distance from the optical axis.

4. The imaging lens assembly of claim 3, wherein the first light blocking surface faces towards the reflective element, the first light blocking surface comprises a reverse inclined portion, and the reverse inclined portion is gradually away from the reflective element in a direction away from the optical axis.

5. The imaging lens assembly of claim 4, wherein the first angle is formed between the reverse inclined portion and the optical axis, the first angle is θa, and the following condition is satisfied:
$$- 0.5 \leq cos θ a < 0 .$$

6. The imaging lens assembly of claim 1, wherein the protruding structures are arranged in an array in a direction away from the optical axis;
wherein, on the section coinciding with the optical axis, the top of one of the protruding structures closest to the optical axis is taken as a reference point, a distance between the reference point and the optical axis and in a direction perpendicular to the optical axis is X, a distance between the reference point and the reflective element or between the reference point and the lens element faced by the first light blocking surface and in a direction parallel to the optical axis is Y, and the following condition is satisfied:
$$0.03 < Y / X < 0.76 .$$

7. The imaging lens assembly of claim 6, wherein the protruding structures are further arranged in an array in a direction surrounding the optical axis.

8. The imaging lens assembly of claim 1, wherein a height of each of the protruding structures is H, and the following condition is satisfied:
$$6 μ m < H < 102 μ m .$$

9. The imaging lens assembly of claim 8, wherein the height of each of the protruding structures is H, a height difference between adjacent two of the protruding structures on the section coinciding with the optical axis is ΔH, and the following condition is satisfied:
$$0.05 < Δ H / H < 0.55 .$$

10. The imaging lens assembly of claim 9, wherein the height difference between adjacent two of the protruding structures on the section coinciding with the optical axis is ΔH, and the following condition is satisfied:
$$1.5 μ m < Δ H < 29 μ m .$$

11. The imaging lens assembly of claim 8, wherein a distance between adjacent two of the protruding structures is greater than the height of each of the protruding structures.

12. The imaging lens assembly of claim 1, wherein the light blocking element further comprises:
a second light blocking surface, wherein the second light blocking surface comprises a plurality of strip structures, the strip structures are arranged in an array in a direction surrounding the optical axis, and a cross-section of each of the strip structures is triangular.

13. The imaging lens assembly of claim 12, wherein, on the section coinciding with the optical axis, a second angle is formed between the second light blocking surface and the optical axis, the second angle is θb, and the following condition is satisfied:
$$0.5 < cos θ b < 1.$$

14. The imaging lens assembly of claim 1, wherein the reflective element further comprises:
a second reflecting surface configured to fold the optical axis again.

15. The imaging lens assembly of claim 14, wherein the reflective element further comprises:
an incident surface, wherein the optical axis enters the reflective element through the incident surface; and
an exit surface, wherein the optical axis exits the reflective element through the exit surface;
wherein the incident surface and the exit surface are the same surface.

16. The imaging lens assembly of claim 1, wherein a number of the lens element is at least two, and a distance between the at least two lens elements is variable.

17. An imaging lens assembly, having an optical axis, and comprising:
a lens element, wherein the optical axis passes through the lens element;
a reflective element disposed on an object side or an image side of the lens element, and comprising:
a first reflecting surface configured to fold the optical axis; and
a light blocking element, wherein the light blocking element is opaque, the light blocking element is disposed corresponding to the lens element or the reflective element, and the light blocking element comprises:
a first light blocking surface disposed between the lens element and the reflective element; and
a plurality of protruding structures disposed on the first light blocking surface and arranged in a two-dimensional array, wherein the protruding structures and the first light blocking surface are formed integrally, and each of the protruding structures protrudes from a bottom in a direction away from the first light blocking surface;
wherein, on a section coinciding with the optical axis, a first angle is formed between the first light blocking surface and the optical axis, the first angle is θa, and the following condition is satisfied:
$$0.86 < sin θ a \leq 1.$$

18. The imaging lens assembly of claim 17, wherein the first angle is ea, and the following condition is satisfied:
$$0.96 < sin θ a \leq 1.$$

19. The imaging lens assembly of claim 17, wherein the first angle formed between the first light blocking surface and the optical axis changes with a distance from the optical axis.

20. The imaging lens assembly of claim 19, wherein the first light blocking surface faces towards the reflective element, the first light blocking surface comprises a reverse inclined portion, and the reverse inclined portion is gradually away from the reflective element in a direction away from the optical axis.

21. The imaging lens assembly of claim 20, wherein the first angle is formed between the reverse inclined portion and the optical axis, the first angle is θa, and the following condition is satisfied:
$$- 0.5 \leq cos θ a < 0 .$$

22. The imaging lens assembly of claim 17, wherein the protruding structures are arranged in an array in a direction away from the optical axis;
wherein, on the section coinciding with the optical axis, a top of one of the protruding structures closest to the optical axis is taken as a reference point, a distance between the reference point and the optical axis and in a direction perpendicular to the optical axis is X, a distance between the reference point and the reflective element or between the reference point and the lens element faced by the first light blocking surface and in a direction parallel to the optical axis is Y, and the following condition is satisfied:
$$0.03 < Y / X < 0.76 .$$

23. The imaging lens assembly of claim 22, wherein the protruding structures are further arranged in an array in a direction surrounding the optical axis.

24. The imaging lens assembly of claim 17, wherein a height of each of the protruding structures is H, and the following condition is satisfied:
$$6 μ m < H < 102 μ m .$$

25. The imaging lens assembly of claim 24, wherein the height of each of the protruding structures is H, a height difference between adjacent two of the protruding structures on the section coinciding with the optical axis is ΔH, and the following condition is satisfied:
$$0.05 < Δ H / H < 0.55 .$$

26. The imaging lens assembly of claim 25, wherein the height difference between adjacent two of the protruding structures on the section coinciding with the optical axis is ΔH, and the following condition is satisfied:
$$1.5 μ m < Δ H < 29 μ m .$$

27. The imaging lens assembly of claim 24, wherein a distance between adjacent two of the protruding structures is greater than the height of each of the protruding structures.

28. The imaging lens assembly of claim 17, wherein the light blocking element further comprises:
a second light blocking surface, wherein the second light blocking surface comprises a plurality of strip structures, the strip structures are arranged in an array in a direction surrounding the optical axis, and a cross-section of each of the strip structures is triangular.

29. The imaging lens assembly of claim 28, wherein, on the section coinciding with the optical axis, a second angle is formed between the second light blocking surface and the optical axis, the second angle is θb, and the following condition is satisfied:
$$0.5 < cos θ b < 1.$$

30. The imaging lens assembly of claim 17, wherein the reflective element further comprises:
a second reflecting surface configured to fold the optical axis again.

31. The imaging lens assembly of claim 30, wherein the reflective element further comprises:
an incident surface, wherein the optical axis enters the reflective element through the incident surface; and
an exit surface, wherein the optical axis exits the reflective element through the exit surface;
wherein the incident surface and the exit surface are the same surface.

32. An imaging lens assembly, having an optical axis, and comprising:
an optical element, wherein the optical element is translucent, and the optical axis passes through the optical element;
an image sensor configured to sense a light, and disposed corresponding to the optical element; and
a light blocking element, wherein the light blocking element is opaque, the light blocking element is disposed corresponding to the optical element or the image sensor, and the light blocking element comprises:
a first light blocking surface disposed between the optical element and the image sensor; and
a plurality of protruding structures disposed on the first light blocking surface and arranged in a two-dimensional array, wherein the protruding structures and the first light blocking surface are formed integrally, a section of a bottom of each of the protruding structures is circular, and each of the protruding structures protrudes from the bottom in a direction away from the first light blocking surface to form an arc surface on a top of each of the protruding structures;
wherein, on a section coinciding with the optical axis, a first angle is formed between the first light blocking surface and the optical axis, the first angle is θa, and the following condition is satisfied:
$$0.86 < sin θ a \leq 1.$$

33. The imaging lens assembly of claim 32, wherein the first angle is θa, and the following condition is satisfied:
$$0.96 < sin θ a \leq 1.$$

34. The imaging lens assembly of claim 32, wherein the first angle formed between the first light blocking surface and the optical axis changes with a distance from the optical axis.

35. The imaging lens assembly of claim 34, wherein the first light blocking surface faces towards the optical element, the first light blocking surface comprises a reverse inclined portion, and the reverse inclined portion is gradually away from the optical element in a direction away from the optical axis.

36. The imaging lens assembly of claim 35, wherein the first angle is formed between the reverse inclined portion and the optical axis, the first angle is θa, and the following condition is satisfied:
$$- 0.5 \leq cos θ a < 0.$$

37. The imaging lens assembly of claim 32, wherein the protruding structures are arranged in an array in a direction away from the optical axis;
wherein, on the section coinciding with the optical axis, the top of one of the protruding structures closest to the optical axis is taken as a reference point, a distance between the reference point and the optical axis and in a direction perpendicular to the optical axis is X, a distance between the reference point and the optical element faced by the first light blocking surface and in a direction parallel to the optical axis is Y2, and the following condition is satisfied:
$$0.03 < Y2 / X < 0.76 .$$

38. The imaging lens assembly of claim 37, wherein the protruding structures are further arranged in an array in a direction surrounding the optical axis.

39. The imaging lens assembly of claim 32, wherein a height of each of the protruding structures is H, and the following condition is satisfied:
$$6 µm < H < 102 µm .$$

40. The imaging lens assembly of claim 39, wherein the height of each of the protruding structures is H, a height difference between adjacent two of the protruding structures on the section coinciding with the optical axis is ΔH, and the following condition is satisfied:
$$0.05 < Δ H / H < 0.55 .$$

41. The imaging lens assembly of claim 39, wherein a distance between adjacent two of the protruding structures is greater than the height of each of the protruding structures.

42. The imaging lens assembly of claim 32, wherein the light blocking element further comprises:
a second light blocking surface, wherein the second light blocking surface comprises a plurality of strip structures, the strip structures are arranged in an array in a direction surrounding the optical axis, and a cross-section of each of the strip structures is triangular.

43. The imaging lens assembly of claim 42, wherein, on the section coinciding with the optical axis, a second angle is formed between the second light blocking surface and the optical axis, the second angle is θb, and the following condition is satisfied:
$$0.5 < cos θ b < 1.$$

44. An imaging lens assembly, having an optical axis, and comprising:
a lens element, wherein the optical axis passes through the lens element; and
a light blocking element, wherein the light blocking element is opaque, the light blocking element is disposed corresponding to the lens element, and the light blocking element comprises:
a first light blocking surface facing towards an image side, and disposed adjacent to the lens element; and
a plurality of protruding structures disposed on the first light blocking surface and arranged in a two-dimensional array, wherein the protruding structures and the first light blocking surface are formed integrally, a section of a bottom of each of the protruding structures is circular, and each of the protruding structures protrudes from the bottom in a direction away from the first light blocking surface to form an arc surface on a top of each of the protruding structures;
wherein, on a section coinciding with the optical axis, a first angle is formed between the first light blocking surface and the optical axis, the first angle is θa, and the following condition is satisfied:
$$0.86 < sin θ a \leq 1.$$

45. The imaging lens assembly of claim 44, wherein the first angle is θa, and the following condition is satisfied:
$$0.96 < sin θ a \leq 1.$$

46. The imaging lens assembly of claim 44, wherein the first angle formed between the first light blocking surface and the optical axis changes with a distance from the optical axis.

47. The imaging lens assembly of claim 46, wherein the first light blocking surface faces towards the lens element, the first light blocking surface comprises a reverse inclined portion, and the reverse inclined portion is gradually away from the lens element in a direction away from the optical axis.

48. The imaging lens assembly of claim 47, wherein the first angle is formed between the reverse inclined portion and the optical axis, the first angle is θa, and the following condition is satisfied:
$$- 0.5 \leq cos θ a < 0.$$

49. The imaging lens assembly of claim 44, wherein the protruding structures are arranged in an array in a direction away from the optical axis;
wherein, on the section coinciding with the optical axis, the top of one of the protruding structures closest to the optical axis is taken as a reference point, a distance between the reference point and the optical axis and in a direction perpendicular to the optical axis is X, a distance between the reference point and the lens element faced by the first light blocking surface and in a direction parallel to the optical axis is Y, and the following condition is satisfied:
$$0.03 < Y / X < 0.76 .$$

50. The imaging lens assembly of claim 49, wherein the protruding structures are further arranged in an array in a direction surrounding the optical axis.

51. The imaging lens assembly of claim 44, wherein a height of each of the protruding structures is H, and the following condition is satisfied:
$$6 µm < H < 102 µm .$$

52. The imaging lens assembly of claim 51, wherein the height of each of the protruding structures is H, a height difference between adjacent two of the protruding structures on the section coinciding with the optical axis is ΔH, and the following condition is satisfied:
$$0.05 < Δ H / H < 0.55 .$$

53. The imaging lens assembly of claim 52, wherein the height difference between adjacent two of the protruding structures on the section coinciding with the optical axis is ΔH, and the following condition is satisfied:
$$1.5 µm < Δ H < 29 µm .$$

54. The imaging lens assembly of claim 51, wherein a distance between adjacent two of the protruding structures is greater than the height of each of the protruding structures.

55. The imaging lens assembly of claim 44, wherein the light blocking element further comprises:
a second light blocking surface, wherein the second light blocking surface comprises a plurality of strip structures, the strip structures are arranged in an array in a direction surrounding the optical axis, and a cross-section of each of the strip structures is triangular.

56. The imaging lens assembly of claim 55, wherein, on the section coinciding with the optical axis, a second angle is formed between the second light blocking surface and the optical axis, the second angle is θb, and the following condition is satisfied:
$$0.5 < cos θ b < 1.$$

57. An electronic device, comprising:
the imaging lens assembly of claim 1.

58. An electronic device, comprising:
the imaging lens assembly of claim 17.

59. An electronic device, comprising:
the imaging lens assembly of claim 32.

60. An electronic device, comprising:
the imaging lens assembly of claim 44.
